(19) United States
(12) Patent Application Publication
(10) Pub. No.: US 2025/0348656 A1
(43) Pub. Date: Nov. 13, 2025

(54) METHOD, SERVER, AND USER TERMINAL FOR PROVIDING TRANSFORMED CONTENT THROUGH CHATROOM

(71) Applicant: KAKAO CORP., Jeju-si (KR)

(72) Inventors: Bo Hyeon LIM, Seongnam-si (KR); Ji Hyun SIM, Seongnam-si (KR); Song Hyun KIM, Seongnam-si (KR); Chan Hui SEOK, Seongnam-si (KR); Seung Hwan KIM, Seongnam-si (KR)

(21) Appl. No.: 18/989,708

(22) Filed: Dec. 20, 2024

(30) Foreign Application Priority Data
May 9, 2024 (KR) 10-2024-0061397

(51) Int. Cl. G06F 40/151; G06F 40/103

(52) U.S. Cl. CPC G06F 40/151; G06F 40/103

(57) ABSTRACT

Proposed is a method for providing a transformed content by a server through a chatroom. The method may include receiving configuration information related to content transformation applied to at least one selected chatroom from a terminal, wherein the configuration information comprises a transformation condition, a transformation rule, and a deactivation condition for disabling application of the configuration information. The method may also include applying the configuration information to the selected chatroom, and when the deactivation condition is satisfied, disabling the application of the configuration information to the selected chatroom. Applying the configuration information may include receiving a transmission request for the input content through the selected chatroom from a participant terminal of the selected chatroom, and when the input content satisfies the transformation condition, transmitting the transformed content, in which the input content is transformed according to the transformation rule, to the participant terminal through the selected chatroom.

### CROSS-REFERENCE TO RELATED APPLICATION

This application claims priority to and the benefit of Korean Patent Application No. 10-2024-0061397 filed on May 9, 2024, the disclosure of which is incorporated herein by reference in its entirety.

### BACKGROUND

### Technical Field

The present disclosure relates to a technology for providing a transformed content by applying a transformation rule to a content in a chat service.

### Description of Related Technology

Recent chat services support the transmission of various multimedia contents, such as images, videos, and emojis, in addition to simple text messages. Some chat services also offer features such as recommending multimedia contents related to the text entered by users in chat messages, to convey the non-verbal emotions intended by the users.

Recently, Internet-based services have frequently incorporated Easter eggs, which are hidden secret features or fun elements that users can discover either incidentally or intentionally. Easter eggs spark users' curiosity and encourage the users to explore what is hidden.

Efforts are being made to incorporate the aforementioned changes in the Internet-based services into the chat services as well. Specifically, the operators and developers of the chat services are trying to introduce features that can engage the users' interest in the form of Easter eggs within the chat services.

### SUMMARY

The present disclosure provides a feature that enables a server to transmit an input content entered by a user through a chatroom as a transformed content, in which the input content is transformed according to a transformation rule, to attract the attention or arouse the interest of chatroom participants.

The present disclosure also provides a feature that enables the server to determine whether a condition to disable the application of configuration information related to content transformation applied to a chatroom is satisfied, and to disable the application of configuration information at an appropriate time intended by a setter.

In one aspect, there is provided a method for providing a transformed content by a server through a chatroom, the method including: receiving configuration information related to content transformation applied to at least one selected chatroom from a terminal, wherein the configuration information comprises a transformation condition, a transformation rule, and a deactivation condition for disabling application of the configuration information; applying the configuration information to the selected chatroom; and when the deactivation condition is satisfied, disabling the application of the configuration information to the selected chatroom. Applying the configuration information includes: receiving a transmission request for the input content through the selected chatroom from a participant terminal of the selected chatroom; and when the input content satisfies the transformation condition, transmitting the transformed content, in which the input content is transformed according to the transformation rule, to the participant terminal through the selected chatroom.

The configuration information may be set differently depending on the selected chatroom.

Disabling the application of the configuration information may include determining whether the deactivation condition is satisfied based on reference information specified by the terminal.

The configuration information may not be provided to the participant terminal of the selected chatroom.

A starting point for the deactivation condition may be a point in time when initial transmission of the transformed content according to the configuration information is performed.

An artificial intelligence (AI) model may be used for at least one of: determining whether the transformation condition is satisfied, determining the transformed content according to the transformation rule, and determining whether the deactivation condition is satisfied.

The transformation condition may be whether the input content corresponds to a transformation target content or a similar content of the transformation target content according to a predetermined criterion.

The configuration information may be stored in the server or terminal, and receiving the configuration information may include receiving a request to retrieve the stored configuration information from the terminal.

Transmitting the transformed content may include determining one content selected from a transformation variant content set corresponding to the input content according to the transformation rule as a transformed content.

At least one content from the transformation variant content set may be generated by an AI model based on the transformation condition.

Transmitting the transformed content may include determining the transformed content based on chat history of the selected chatroom.

The transformed content may include a predetermined type of additional information for the input content.

The method may further include updating the additional information through a predefined database or an AI model.

The transformation condition may be whether the input content is related to a correct answer to a quiz provided in the selected chatroom, and the transformed content may be a masked content that makes the correct answer unidentifiable.

While the configuration information is applied to the selected chatroom, the masked content may be provided for any content related to the correct answer.

In another aspect, there is provided a server providing a transformed content through a chatroom, the server including a memory storing instructions and a processor connected to the memory and configured to execute the instructions to: receive configuration information related to content transformation applied to at least one selected chatroom from a terminal, wherein the configuration information comprises a transformation condition, a transformation rule, and a deactivation condition for disabling application of the configuration information; apply the configuration information to the selected chatroom; and when the deactivation condition is satisfied, disable the application of the configuration information to the selected chatroom. Applying the configuration information may include: receiving a transmission request for the input content through the selected chatroom from a participant terminal of the selected chatroom; and when the input content satisfies the transformation condition, transmitting the transformed content, in which the input content is transformed according to the transformation rule, to the participant terminal through the selected chatroom.

In yet another aspect, there is provided a method for displaying a transformed content through a chatroom by a terminal, the method including: transmitting an input content to a server through a selected chatroom with configuration information applied, wherein the configuration information comprises a transformation condition, a transformation rule, and a deactivation condition for disabling the application of the configuration information; when the input content satisfies the transformation condition, displaying in the selected chatroom a transformed content in which the input content is transformed according to the transformation rule; and when the deactivation condition is satisfied, displaying a new input content in the selected chatroom in response to transmission of the new input content.

In yet another aspect, there is provided a terminal displaying a transformed content through a chatroom, the terminal comprising a memory storing instructions and a processor connected to the memory and configured to execute the instructions to: transmit an input content to a server through a selected chatroom with configuration information applied, wherein the configuration information comprises a transformation condition, a transformation rule, and a deactivation condition for disabling the application of the configuration information; when the input content satisfies the transformation condition, display in the selected chatroom a transformed content in which the input content is transformed according to the transformation rule; and when the deactivation condition is satisfied, display a new input content in the selected chatroom in response to transmission of the new input content.

### BRIEF DESCRIPTION OF THE DRAWINGS

FIG. 1 is a diagram illustrating an example of a network environment according to one embodiment of the present disclosure.

FIG. 2 is a flowchart illustrating a method in which a server of the present disclosure provides a transformed content through a selected chatroom.

FIG. 3 schematically illustrates a database in which configuration information is set differently depending on a chatroom by a server of the present disclosure.

FIGS. 4 to 10 exemplarily illustrate a method for a terminal and a participant terminal to display a transformed content according to one embodiment of the present disclosure.

FIG. 11 is a flowchart for explaining a method in which a participant terminal of a selected chatroom of the present disclosure displays a transformed content through the selected chatroom.

### DETAILED DESCRIPTION

Description will now be given in detail according to exemplary embodiments disclosed herein, with reference to the accompanying drawings. For the sake of brief description with reference to the drawings, the same or equivalent components may be provided with the same or similar reference numbers, and description thereof will not be repeated. In addition, in the following description of the embodiments, a detailed description of known functions and configurations incorporated herein will be omitted when it may impede the understanding of the embodiments.

While terms including ordinal numbers, such as “first” and “second,” etc., may be used to describe various components, such components are not limited by the above terms. The above terms are used only to distinguish one component from another.

The singular forms are intended to include the plural forms, unless the context clearly indicates a different meaning.

In this application, the described steps may be carried out in any sequence, except in cases where a clearly defined cause-and-effect relationship necessitates a specific order.

It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, the present disclosure will be described with reference to the attached drawings.

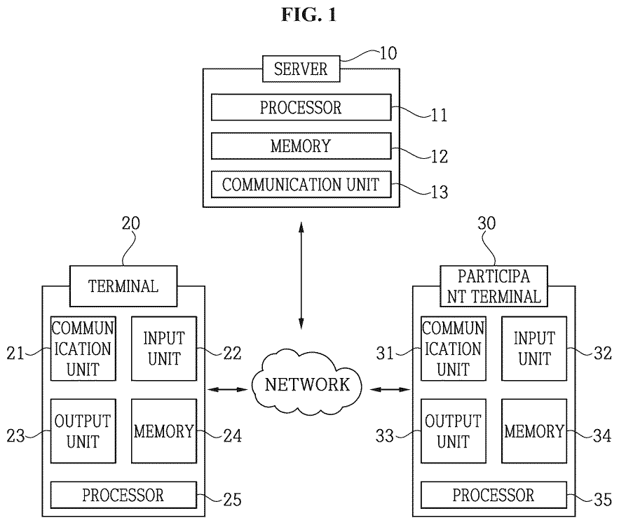

FIG. 1 is a diagram illustrating an example of a network environment according to one embodiment of the present disclosure.

A network environment according to one embodiment of the present disclosure illustrated in FIG. 1 may include a server 10 and a terminal and participant terminal 20 and 30. The terminal and participant terminal 20 and 30 may include at least one terminal 20 and 30 connected to the server 10 over a network. In FIG. 1, a terminal 20 and a participant terminal 30 are illustrated as examples of terminals used by a user or operator.

The terminal 20 may be a terminal of an account registered as an administrator or operator of a chat service. Additionally, in some cases, the terminal 20 may be a terminal of a user account with authority to manage or operate a chatroom. The participant terminal 30 may be a terminal of a user account registered with the server 10 that provides the chat service.

Hereinafter, for convenience of explanation, the terminal 20 is described as a terminal of an administrator account of the chat service, and the participant terminal 30 is described as a terminal participating in a selected chatroom. However, the present disclosure is not limited or constrained by the specific functions that can be performed by the terminals 20 and 30. Communication schemes for a network is not limited. The communication schemes may include not only a communication scheme to utilize a telecommunication network (for example, a mobile communication network, wired Internet, wireless Internet, and a broadcast network), but also a short-range radio communication scheme.

In the present disclosure, the server 10 may be a device capable of transmitting and receiving information through communication with the terminal and participant terminal 20 and 30 over a network. The server 10 may be implemented as a computer device or a plurality of computer devices that provide commands, codes, files, content, services, etc.

The server 10 may include a processor 11, a memory 12, and a communication unit 13.

The processor 11 controls the overall operation of the memory 12 and the communication unit 13 to provide a service of providing at least one chatroom and a transformed content to the terminal and participant terminal 20 and 30.

The memory 12 functions as a storage medium and may store a number of application programs running on the server 10, as well as data and commands for operation of the server 10. In one embodiment, the memory 12 may store an application that provides a social media service, messenger service, or streaming service that can provide a chatroom.

The memory 12 may be provided in the form of various hardware storage devices such as an ROM, an RAM, a flash drive, a hard drive, etc. or may be provided in the form of web storage.

The communication unit 13 may communicate with the terminal and participant terminal 20 and 30 in a wired/wireless manner over a network.

The server 10 of the present disclosure provides a chatroom to the terminal and participant terminal 20 and 30 and may transmit a content through the chatroom.

In the present disclosure, the server 10 may receive configuration information related to content transformation applied to at least one selected chatroom from the terminal 20. Here, the configuration information may include a transformation condition, a transformation rule, and a deactivation condition for disabling the application of the configuration information. The server 10 may apply the configuration information to the selected chatroom and, upon satisfaction of the deactivation condition, may disable the application of the configuration information to the selected chatroom. When applying the configuration information, the server 10 receives a transmission request for an input content through the selected chatroom from the participant terminal 30 of the chatroom. When the input content satisfies the transformation condition, the server 10 may transmit a transformed content, in which the input content is transformed according to the transformation rule, to the participant terminal 30 through the selected chatroom.

Here, the selected chatroom refers to a chatroom chosen by the user of the terminal 20 among at least one chatroom that the user of the terminal 20 is able to manage or operate. The user of the terminal 20 may be an operator (or administrator) of the chat service.

Here, a chatroom that can be chosen as a selected chatroom may be a chatroom of a specific type that is predetermined in advance. In some cases, the chat service may offer various types of chatrooms. For example, the types of chatrooms may include regular chatrooms, group chatrooms, anonymous chatrooms, and open chatrooms (‘Open Chat’ is a registered trademark of Kakao Corporation) that users can join through a general URL. Here, the user of the terminal 20 may select a selected chatroom only from a specific type of chatrooms. In the above-described example, the user of the terminal 20 may select a selected chatroom only from open chatrooms.

Here, the configuration information refers to information about setting for transforming an input content into a transformed content according to a transformation rule and transmitting the transformed content when the input content entered in a selected chatroom satisfies a transformation condition. Specifically, the configuration information may include the transformation condition, a transformation rule, and a deactivation condition for disabling the application of the configuration information.

The configuration information may be set or modified by the operator or administrator who created the selected chatroom. As an example, configuration information may be set by the creator of a chatroom when the chatroom is created. As another example, configuration information may be newly entered or modified by the creator or administrator for a specific chatroom among multiple chatrooms after the chatroom is created. The configuration information may include a transformation condition, a transformation rule, and a deactivation condition to disable the application of the configuration information.

Here, the input content refers to a content that the participant terminal 30 of the chatroom requests the server 10 to transmit to another participant terminal 30 through the chatroom. If the configuration information is not applied to the chatroom, the server 10 transmits the input content as is to another participant terminal 30 through the chatroom. However, if the configuration information is applied to the chatroom, the server 10 may transform the input content into a transformed content according to the transformation rule and transmit the transformed content when the input content satisfies the transformation condition.

Here, the transformed content refers to a content where the transformation rule is applied to the input content. Various visual or auditory effects may be applied to the transformed content, capturing the interest or attention of chatroom participants.

As another example, the transformed content may be used to perform a specific feature in a specific chatroom. For instance, if a specific chatroom is hosting a quiz game, the transformed content may be a masked content that obscures the correct answer to the quiz. In such cases, even if a user inputs the correct answer to the quiz, the masked content may be provided instead of the input content related to the correct answer, effectively preventing the correct answer from being revealed to other users.

Here, the transformation condition refers to a condition for determining whether the input content is a target to be transformed. For example, the transformation condition may be defined as a case where the input content completely matches a predetermined transformation target content. Additionally, the transformation condition may be defined not only as a case where the input content completely matches a predetermined transformation target content, but also a case where the input content falls within a range of similarity according to specific criteria. Examples of various transformation conditions are described below.

Here, the transformation rule refers to a rule that transforms an input content into a transformed content. The transformed content may be an input content with a visual or auditory effect applied.

Here, the deactivation condition refers to a condition under which the application of configuration information to the selected chatroom is disabled. If the server 10 determines that the deactivation condition for the configuration information is satisfied, the server 10 may disable the application of the configuration information to the selected chatroom.

The server 10 may not provide a participant terminal with information on whether configuration information is applied to a chatroom and specific details about the configuration information. In such cases, a participant account in the chatroom may incidentally enter an input content that satisfies the transformation condition, thereby discovering the application of the configuration information. Based on this discovery, other participant accounts in the chatroom may also recognize the application of the configuration information and attempt to enter an additional input content that satisfies the transformation condition.

The terminals 20 and 30 include the terminal 20 operating a selected chatroom and a participant terminal 30 participating in the selected chatroom. The terminals 20 and 30 may include communication units 21 and 31, input units 22 and 32, output units 23 and 33, memories 24 and 34, and processor 25 and 35.

The communication units 21 and 31 may communicate with the server 10 or other terminals in a wired/wireless manner.

The input units 22 and 32 may receive various information through a user's operation and input. Such input units 22 and 32 may be touch screen modules, keyboards, mouses, buttons, cameras, styluses, microphones, etc.

The terminals 20 and 30 may receive a user interaction through the input units 22 and 32. The interaction refers to the action of the user's operating an input unit to enter information reflecting the user's selection or intention into the terminals 20 and 30. For example, the interaction may include touching on a touchscreen, clicking with a mouse, typing on a keyboard, providing voice input through a microphone, capturing an image using a camera, recognizing movements through a motion sensor, and the like.

The output units 23 and 33 may output various information. The output units 23 and 33 may be display devices, speakers, vibration generating devices, tactile In some cases, the output units 23 and 33 may be devices (e.g., Bluetooth earphone) respectively connected to the terminals 20 and 30 through wired or wireless communication (e.g., short-range radio communication such as Bluetooth) to receive and output signals.

Each of the memories 24 and 34 functions as a storage medium and may store a plurality of application programs running on a corresponding one of the user terminal 20 and 30, as well as and data and instructions for operating the corresponding one of the user terminal 20 and 30. Each of the memories 24 and 34 may be provided in the form of any of various hardware storage devices such as an ROM, an RAM, a flash drive, a hard drive, etc. or may be provided in the form of web storage. In one embodiment, an application providing a chat service may be stored in the memories 24 and 34.

The processors 25 and 35 may control the overall operation of the communication units 21 and 31, input units 22 and 32, output units 23 and 33, and memories 24 and 34 to execute an application related to a social media service or messenger service including a chatroom.

In the present disclosure, the participant terminal 30 may transmit an input content to the server 10 through a selected chatroom with configuration information applied. Here, the configuration information may include a transformation condition, a transformation rule, and a deactivation condition for disabling the application of the configuration information. If the input content satisfies the transformation condition, the participant terminal 30 may display in the selected chatroom the transformed content in which the input content is transformed according to the transformation rule. When the deactivation condition is satisfied, the participant terminal 30 may display a new input content as is in the selected chatroom, without transformation, in response to the transmission of the new input content.

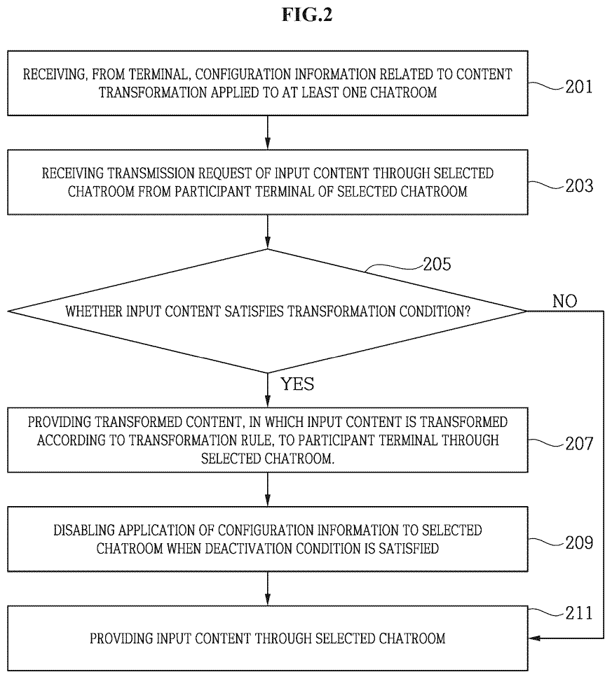

Hereinafter, with reference to FIGS. 2 to 10, one embodiment of a method in which a server 10 of the present disclosure provides a transformed content through a selected chatroom will be described.

FIG. 2 is a flowchart for explaining a method in which the server 10 of the present disclosure provides a transformed content through a selected chatroom.

In operation 201, the server 10 receives configuration information related to content transformation applied to at least one chatroom from the terminal 20.

The terminal 20 may be an administrator for at least one chatroom of a chat service provided by the server 10. The server 10 may receive information from the terminal 20 indicating that at least one chatroom, for which the account of the terminal 20 has administrative authority, is selected as a selected chatroom.

The server 10 may receive configuration information for the selected chatroom from the terminal 20. The configuration information may include a variety of information. Specifically, the configuration information may include a transformation condition, a transformation rule, and a deactivation condition to disable the application of the configuration information.

The transformation condition may be defined based on various criteria. For example, the transformation condition may be defined as a case where an input content completely matches a predetermined transformation target content. As another example, the transformation condition may be defined not only as a case where the input content completely matches the predetermined transformation target content, but also as a case where the input content falls within a range of similarity according to specific criteria.

The range of similarity for the transformation condition may be determined in various ways. For example, if the transformation condition specifies a English word or expression, a corresponding Korean word or expression may fall within the range of similarity. Additionally, synonyms with similar meanings, words with different spacing, and words with minor spelling errors may also fall within the range of similarity.

The transformation rule may be a rule that modifies input content by changing the size, color, or font of the content to attract a user's attention or arouse the user's interest. Additionally, the transformation rule may involve adding additional information related to a specific keyword. For example, the transformation rule may specify that when an input related to a particular soccer player is received, additional information such as the player's club or jersey number is provided.

A single configuration information item may include a plurality of transformation rules. Accordingly, in one configuration, a single input content may be transformed into a plurality of transformed contents according to the plurality of transformation rules. In this manner, a plurality of variant contents that can be generated from transformation of a single input content may be collectively referred to as a transformation variant content set. In such cases, the input content satisfying the target transformation condition may be transformed into one transformed content from the corresponding transformation variant content set. The transformed content may be randomly selected from the transformation variant content set. In doing so, participant accounts in a chatroom where the configuration information is applied may receive diverse transformed contents, even for an identical or similar input content.

A deactivation condition may be defined according to various criteria. For example, the deactivation condition may be defined based on a specific point in time, such as a particular hour or date. For example, the deactivation condition may be defined as a specific point in time, such as 23:59:59 on Dec. 25, 2024.

As another example, the deactivation condition may be defined as a condition such as the occurrence of a specific event. For example, the deactivation condition may be set as “until the South Korean national team is eliminated from the World Cup.” In such cases, the server 10 may determine whether the deactivation condition is satisfied based on predetermined reference information. The server 10 may receive, from the terminal 20, the reference information that is to be used to determine whether the deactivation condition is satisfied.

As another example, the deactivation condition may be defined as a case where a criterion predetermined by the terminal 20 is satisfied. For example, the deactivation condition may be defined by the terminal 20 as “when the number of correct answers to the quiz exceeds 2.” In such cases, the messages of users who enter first and second correct answers in the selected chatroom may not satisfy the deactivation condition. Accordingly, the server 10 may transform the input content into a transformed content and provide the transformed content. However, messages from users who enter a third or subsequent correct answer may satisfy the deactivation condition. In this case, the server 10 may provide the input content as is to the selected chatroom.

When the deactivation condition is satisfied, the server 10 may no longer provide the transformed content and instead provide the input content as is, even if the content input in the selected chatroom satisfies the transformation condition.

In operation 201, the server 10 may receive information on selection of two or more chatrooms as selected chatrooms from the terminal 20. Then, the server 10 may receive different configuration information for each selected chatroom from the terminal 20. Specifically, the server 10 may receive information from the terminal 20 indicating that both the first and second chatrooms are selected as selected chatrooms and may receive configuration information with different transformation conditions, transformation rules, and deactivation conditions for each of the first and second chatrooms.

The account of the terminal 20 may input configuration information related to content transformation suitable for the subject, topic, mood, and details of each chatroom. For example, in the case of a chatroom with soccer as a topic, the account of the terminal 20 may input configuration information to set the names of soccer players or words related to soccer matches as transformation target contents.

As described above, the account of the terminal 20 may set different configuration information for each chatroom. However, in some cases, particular configuration information may be set to apply commonly across a plurality of chatrooms. To support the setting of such common configuration information, the server 10 may store the common configuration information and provide a function for retrieving and applying the common configuration information from the terminal 20.

For example, the account of the terminal 20 may set content transformation configuration information suitable for each topic in a plurality of chatrooms managed by the account of the terminal 20. However, during the Christmas season, the account of the terminal 20 may also set configuration information related to transformation of Christmas content in the plurality of chatrooms. In this case, the terminal 20 may select the plurality of chatrooms as selected chatrooms, retrieve pre-stored content transformation configuration information related to Christmas in the plurality of chatrooms, and input the retrieved configuration information into the server 10.

The server 10 may apply configuration information to a selected chatroom. Details about how the server 10 applies the configuration information to the selected chatroom will be described in operations 203, 205, and 207.

In operation 203, the server 10 receives a transmission request for an input content through the selected chatroom from the participant terminal 30 of the chatroom.

The server 10 may receive the input content from the participant terminal 30. Specifically, the participant terminal 30 may receive the input content from a user of the participant terminal 30 through an input window of the selected chatroom. The server 10 may receive, from the participant terminal 30, a request to transmit the input content entered in an input window of a chatroom to another participant terminal through the selected chatroom.

In operation 205, the server 10 determines whether the input content satisfies a predetermined transformation condition.

The server 10 may not provide the configuration information to the participant terminal 30 of the selected chatroom. In such cases, users participating in the selected chatroom may discover the target transformation condition incidentally. Compared to cases where the server 10 provides the configuration information in advance, the users who accidentally discover the transformation condition may feel greater excitement from uncovering new features (or effects). In such cases, the time spent or the frequency of use of the selected chatroom may increase as users explore other transformation conditions.

As described above, the transformation condition may be set according to various criteria. The server 10 may determine whether the input content satisfies the transformation condition.

In some cases, the server 10 may use an artificial intelligence (AI) model to determine whether the target transformation condition is satisfied. Here, the AI model may be incorporated in the server 10, incorporated in another server accessible to the server 10, or provided in a form that receives data through an application programming interface (API) from another server. For example, if the transformation condition includes a synonym of a specific transformation target content, the server 10 may use the AI model to identify whether the input content is a synonym of the transformation target content.

As another example, if the transformation condition is “South Korea World Cup national team player name,” the server 10 may use the AI model to identify whether the input content corresponds to “South Korea World Cup national team player name.”

In some cases, the selected chatroom may be a chatroom with a quiz feature. In such cases, the transformation condition may correspond to whether the input content is related to the correct answer to a quiz in the quiz chatroom. For example, if the correct answer to the quiz is “Frozen,” the transformation condition may be “Frozen” and “Fro zen” (a synonym with different spacing).

If the input content satisfies the transformation condition, the server 10 performs operation 207. If the input content does not satisfy the transformation condition, the server 10 performs operation 211.

In some cases, unlike in operation 205, the server 10 may provide the transformation condition to the terminal 20 or the participant terminal 30, without determining whether the input content satisfies the transformation condition. In this case, the terminal 20 or participant terminal 30 may independently determine whether the input content satisfies the transformation condition.

In operation 207, if the input content satisfies the transformation condition, the server 10 provides the transformed content, in which the input content is transformed according to the transformation rule, through the selected chatroom.

The server 10 may apply the transformation rule to the input content when the input content satisfies the transformation condition. Specifically, the server 10 may apply various transformation rules to the input content. For example, the server 10 may apply, to the input content, at least one transformation rule among color transformation, size transformation, font transformation, position transformation, shape transformation, angle transformation, animation effects, masking, adding a new content, or adding additional information. The server 10 may select at least one rule from among a plurality of candidate transformation rules applicable to the input content.

The server 10 may determine any one content selected from a transformation variant content set as a transformed content. Here, the transformation variant content set may correspond to input contents to which the transformation rules are applied. For example, if the input content is “Christmas”, the transformation variant content set may be “Christmas+Emoji”, “Christmas+(Christmas in Korean text)”, “Christmas animation effect”, or the like.

The server 10 may determine the transformed content by various methods. As an example, the server 10 may randomly determine any one content from a transformation variant content set as the transformed content. Specifically, the server 10 may store at least one transformed content corresponding to the input content. In this case, the server 10 may randomly determine any one content from the stored transformation variant content set as the transformed content. Here, at least one content from the transformation variant content set may be generated by an AI model based on the transformation conditions.

As another example, the server 10 may determine the transformed content based on chat history of the selected chatroom. For instance, the server 10 may analyze chat messages content of the selected chatroom from the last 3 minutes based on the chat message including the input content and determine the most appropriate transformed content for the conversion.

As a specific example, in the “Chatroom to Support the South Korean World Cup Team” (selected chatroom), a transformation target content such as “goal” may be identified in a chat window. If the server 10 identifies through other chat messages in the “Chatroom to Support the South Korean World Cup Team” that the goal is a comeback goal, the server 10 may provide in the selected chatroom a transformed content in which a transformation rule to transform “goal” (input content) into “goal (winning goal!)” is applied. In the process of determining a transformation rule, the server 10 may analyze the chat history of the selected chatroom using an AI model including natural language processing technology.

The server 10 may include a predetermined type of additional information for the input content. Specifically, when a specific input content is transformed into a transformed content according to a transformation rule, the server 10 may add a predetermined type of additional information for the specific input content.

For example, if a particular input content is the name of a player, the additional information may be information related to at least one of the player's jersey number, records, ranking, position, and club. In this case, the server 10 may update the additional information through a predefined database or AI model.

In some cases, the server 10 may generate a predetermined type of additional information for the input content through the AI model. Specifically, the server 10 may create or receive a new emoji, a emoticon, and a content (additional information) through a generative AI model. Thereafter, the server 10 may add the new additional information obtained from the AI model to the input content.

A specific selected chatroom may offer a quiz feature. Specifically, the selected chatroom may include a chatroom intended for user-to-user conversation and a functional chatroom capable of performing a specific feature. For example, the specific feature may be a quiz feature to be performed in a chatroom.

If the selected chatroom is a chatroom with a quiz feature, a transformed content may be a masked content that makes the correct answer to the quiz unidentifiable. Specifically, when the server 10 receives a transmission request for a content related to the correct answer from the participant terminal 30 in a chatroom with a quiz feature, the server 10 may mask (blind) the content related to the correct answer entered by the participant terminal 30. Here, masking may be replacing a content related to the correct answer with a specific emoji.

While the configuration information is applied to the chatroom with the quiz feature, the server 10 may provide the same masked content for any content related to the correct answer. Specifically, after the server 10 provides the masked content to the participant terminal 30, if the server 10 receives a content related to the correct answer again from another participant terminal in the chatroom with the quiz feature, the server 10 may provide the same masked content, previously provided to the participant terminal 30, to the other participant terminal in the chatroom.

Unlike in operation 207, the server 10 may provide only the transformation target content and the transformation rule to the terminal 20 or participant terminal 30, without providing the transformed content to the selected chatroom. In this case, the terminal 20 or participant terminal 30 may independently transform the input content into the transformation target content if the input content satisfies the transformation condition.

Specifically, when the terminal 20 or participant terminal 30 receives an input for transmitting an input content corresponding to the transformation target content to the selected chatroom, the terminal 20 or participant terminal 30 may display the transformed content according to the transformation rule in the selected chatroom. Here, the transformed content may vary depending on the emojis, emoticons, or contents available on the participant terminal 30.

In operation 209, when it is identified that the deactivation condition is satisfied, the server 10 disables the application of the configuration information to the chatroom.

The server 10 may determine whether the deactivation condition is satisfied based on reference information specified by the terminal 20. For example, if the deactivation condition is “whether South Korea is eliminated from the World Cup,” the reference information may be “sports information provided by a specific website.” Here, the reference information may be provided indirectly through an URL link, etc.

A starting point for the deactivation condition may be a point in time when the initial transmission of the transformed content according to the configuration information is performed. Specifically, the server 10 may not provide information on transformation condition to any participant terminals of the selected chatroom. In this case, the starting point for the deactivation condition may be a point in time when the participant terminal 30 of the selected chatroom performs the initial transmission of the transformed content.

For example, if a transformation condition in a specific selected chatroom is “Christmas,” the deactivation condition may be set as “until the third day from the time when any participant in the selected chatroom first enters ‘Christmas’.”

The server 10 may determine whether the deactivation condition is satisfied using an AI model. For example, if the deactivation condition is “whether South Korea is eliminated from the World Cup,” the server 10 may determine whether South Korea is eliminated from the World Cup, using the AI model. In such cases, the AI model may determine whether the deactivation condition is satisfied, based on chat history of the selected chatroom or sports information provided by a specific website.

After identifying that the deactivation condition is satisfied, the server 10 may receive a transmission request for an input content from the participant terminal 30. In this case, the server 10 may directly transmit the input content received from the participant terminal 30 to the participant terminal 30 of the selected chatroom.

In some cases, when it is identified that the deactivation condition is satisfied, the server 10 may provide the input content to replace the transformed content provided to the selected chatroom. For example, the selected chatroom is a chatroom with a quiz feature, and the server 10 may identify whether the deactivation condition is satisfied. In this case, the server 10 may replace a masked content with a content (input content) related to a correct answer.

In operation 211, the server 10 provides the input content through the selected chatroom.

The server 10 may provide the input content through the selected chatroom if the input content does not satisfy the transformation condition. Here, the input content may be a content entered by a chatroom participant without any transformation applied.

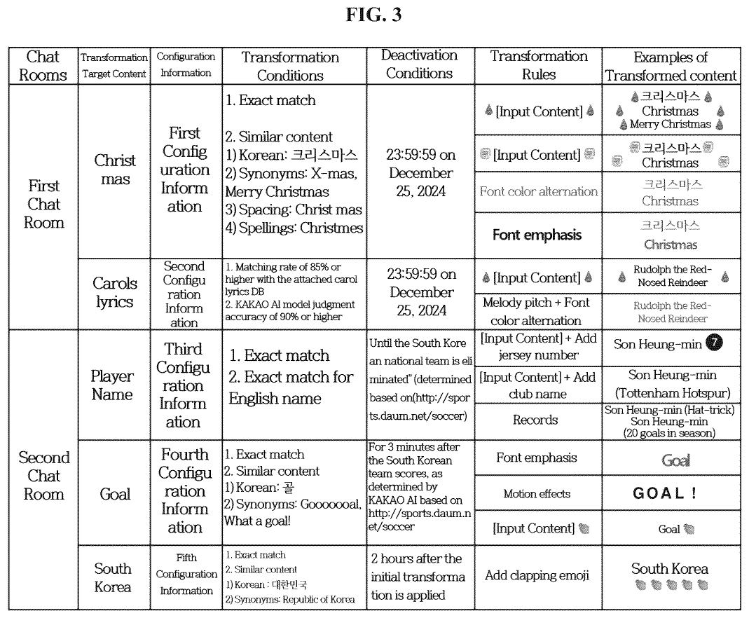

FIG. 3 schematically illustrates an example of a database in which configuration information is set differently depending on a chatroom by a server 10 of the present disclosure.

Referring to FIG. 3, a terminal 20 may select first and second chatrooms among chatrooms managed by the terminal 20 as selected chatrooms. The terminal 20 may set different configuration information for each of the first chatroom and the second chatroom.

The terminal 20 may set first configuration information for the first chatroom, specifying “Christmas” as a target content, “Exact match” and “Similar content” (e.g., Korean version, synonyms, spacing, and spelling) as target conditions, “Emoji addition,” “Font color alternation,” and “Font emphasis” as transformation rules, and “23:59:59 on Dec. 25, 2024” as a deactivation condition.

When applying a specific transformation rule, the server 10 may randomly determine which transformation rule to apply to the input content. For example, the server 10 may randomly determine one of “Emoji addition,” “Font color alternation,” and “Font emphasis.”

The terminal 20 may set second configuration information for the first chatroom, specifying “Carol lyrics” as a target content, “Matching rate of 85% or higher with the attached carol lyrics DB” and “KAKAO AI model judgment accuracy of 90% or higher” as target conditions, “Emoji addition” and “Melody pitch+Font color alternation” as transformation rules, and “23:59:59 on Dec. 25, 2024” as a deactivation condition.

The terminal 20 may provide an attached carol lyrics database to the server 10 to determine whether a transformation condition in the second configuration information is satisfied. Additionally, the terminal 20 or server 10 may use the KAKAO AI model to determine whether a transformation condition is satisfied.

The terminal 20 may set third configuration information for the second chatroom, specifying “Player name” as a target content, “Exact match” and “Exact match for Korean name” as target conditions, “Add jersey number,” “Add club name,” and “Add statistics” as transformation rules, and “Until the Korean national team is eliminated” as a deactivation condition.

In the third configuration information, the terminal 20 may specify “Sports information provided by a specific website” (e.g., https://sports.daum.net/soccer) as reference data to determine whether the deactivation condition is satisfied. In such cases, the server 10 may determine whether the deactivation condition is satisfied, based on the reference data received from the terminal 20.

The terminal 20 may set fourth configuration information for the second chatroom, specifying “Goal” as a target content, “Exact match” and “Similar content” (e.g., Korean versions, synonyms, and spelling variations) as target conditions, “Font emphasis,” “Motion effects,” and “Emoji addition” as transformation rules, and “For 3 minutes after the Korean team scores” as a deactivation condition.

In the fourth configuration information, the terminal 20 may specify “sports information provided by a specific website” (e.g., https://sports.daum.net/soccer) as reference information to determine whether the deactivation condition is satisfied. In this case, the server 10 may determine whether the deactivation condition is satisfied based on the reference information. For example, the server 10 may set “For 3 minutes after the Korean team's score increases on the sports information provided by the specific website” as a deactivation condition and determine whether the deactivation condition is satisfied.

In some cases, the server 10 may determine whether the deactivation condition is satisfied, based on reference information through an AI model. For instance, the AI model may crawl a specific website (reference information) to identify information related to the Korean team's score based on information provided by the specific website. In such cases, the AI model may determine whether the deactivation condition is satisfied, by using a time when score-related information is identified as a starting point.

The terminal 20 may set fifth configuration information for the second chatroom, specifying “South Korea” as a target content, “Exact match” and “Similar content” (e.g., Korean version and variations) as target conditions, “Emoji addition” as a transformation rule, and “2 hours after the first transformation is applied” as a deactivation condition.

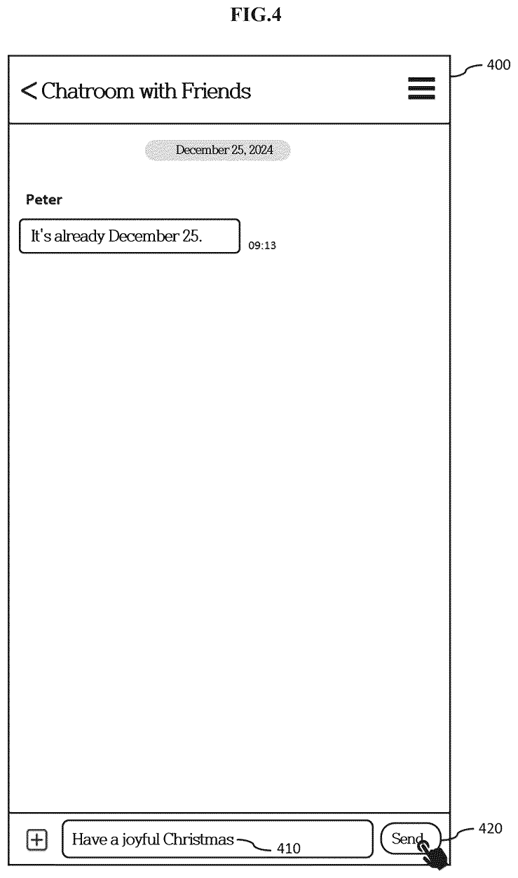

Hereinafter, with reference to FIGS. 4 to 10, an example of a method in which a terminal 20 and a participant terminal 30 of the present disclosure display transformed content will be described.

FIG. 4 illustrates a screen in which a terminal 20 transmits an input content 410 to a server 10 according to one embodiment of the present disclosure.

Referring to FIG. 4, the terminal 20 may transmit the input content 410 to the server 10 through a first chatroom 400. Specifically, the operator or manager of the first chatroom 400 may input an input content such as “Have a joyful Christmas” 410 through an input window of the first chatroom 400. The terminal 20 may transmit an input content such as “Have a joyful Christmas” 410 to the server 10 through the Send interface 420.

The operator of the first chatroom (e.g. Peter) may set configuration information when creating the chatroom. In this case, when the operator (Peter) or a participant (Mike) inputs an input content satisfying a transformation condition, the terminal 20 or participant terminal 30 may display a transformed content in which a transformation rule is applied to the input content.

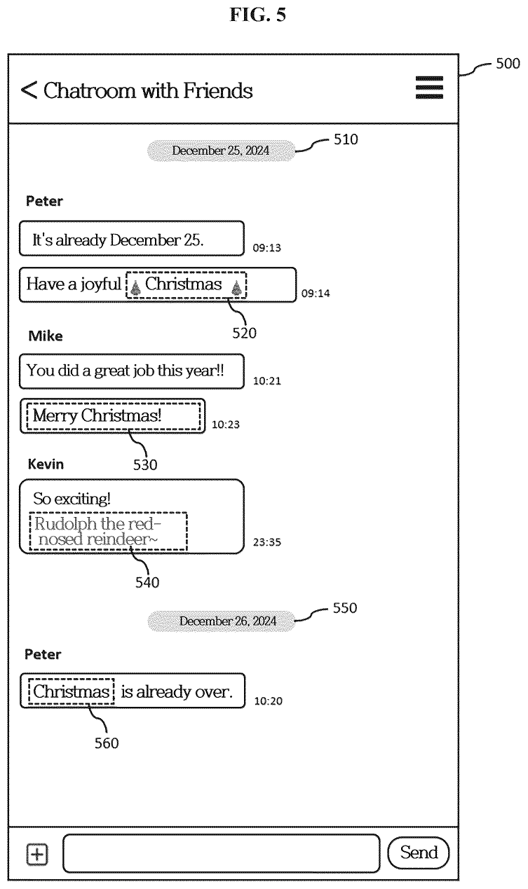

FIG. 5 illustrates a screen in which a terminal 20 according to one embodiment of the present disclosure displays transformed contents 520, 530, and 540 and an input content 560 through a first chatroom 500.

Referring to FIG. 5, the terminal 20 may display the transformed contents 520, 530, and 540 in the first chatroom 500. Here, the first chatroom may be a chatroom to which configuration information is applied. Specifically, the first chatroom may be a chatroom to which configuration information is applied on “Dec. 25, 2024” 510.

When the server 10 receives an input content satisfying the transformation condition from a participant terminal 30 of the first chatroom 500, the server 10 may provide the transformed contents 520, 530, and 540 to the terminal 20 through the first chatroom 500.

Referring to the database in FIG. 3, the transformation condition may be “Christmas” and “Carol lyrics.” In this case, when the server 10 receives a transmission request for the input content such as “Have a joyful Christmas” from the terminal 20, the server 10 may apply the “Add emoji” transformation rule to “Christmas” to provide a transformed content such as “Christmas+Emoji” 520 as shown in FIG. 5.

In addition, when the server 10 receives “Merry Christmas!” from a participant terminal (Mike's terminal), the server 10 may apply the “Font color alternation” transformation rule to “Merry Christmas!” and provide a transformed content such as “Merry Christmas!+Font Color” 530, as shown in FIG. 5.

The server 10 may simultaneously apply a combination of multiple transformation rules to an input content. For example, when the server 10 receives a carol lyric such as “Rudolph the Red-Nosed Reindeer” from a participant terminal (Kevin's terminal), the server 10 may simultaneously apply the “Melody pitch” and “Font color alternation” transformation rules to “Rudolph the Red-Nosed Reindeer” and provide a transformed content such as “Rudolph the Red-Nosed Reindeer+Melody Pitch+Font Color Alternation” 540, as illustrated in FIG. 5.

When it is identified that the deactivation condition is satisfied, the server 10 may disable the application of the configuration information to the first chatroom 500. Here, the deactivation condition may be “23:59:59 on Dec. 25, 2024.” As illustrated in FIG. 5, when the server 10 receives an input content satisfying the transformation condition, such as “Christmas,” from the terminal 20 on “Dec. 26, 2024” 550, the terminal 20 may display “Christmas” 560, without applying any transformation rules.

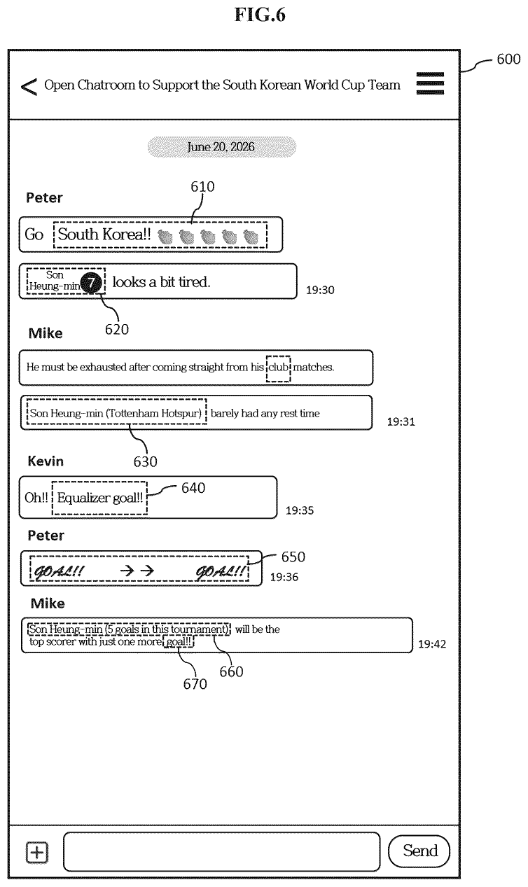

FIG. 6 illustrates a screen in which a terminal 20 according to one embodiment of the present disclosure displays transformed contents 610, 620, 630, 640, 650, and 660 and an input content 670 through a second chatroom 600.

Referring to FIG. 6, the terminal 20 may display the transformed contents 610, 620, 630, 640, 650, and 660 in the second chatroom 600. Each transformed content may have a different transformation rule and a different deactivation condition applied.

The server 10 may not provide a transformation condition to the participant terminal 30 of the second chatroom 600. In such cases, the participant terminal 30 of the second chatroom 600 may discover target conditions such as “South Korea” incidentally. Here, the deactivation condition may be calculated from the time the first transformation is applied to “South Korea.” For example, the deactivation condition may be set to “2 hours after the first transformation to South Korea”.

The terminal 20 may display a transformed content including a predefined type of additional information for the input content. Specifically, if the input content is a player's name, the additional information may be information related to the player's jersey number or club.

For example, when the server 10 receives an input content corresponding to a player's name, such as “Son Heung-min,” from the terminal 20, the server 10 may provide a transformed content by adding the player's jersey number, such as “Son Heung-min\textcircled{7}” 620. In such cases, the terminal 20 may display the transformed content such as “Son Heung-min\textcircled{7}” 620 in the second chatroom.

The server 10 may determine a transformation rule based on chat history. For example, if the server 10 identifies chat history such as “Son Heung-min” and “He must be exhausted after coming straight from his club matches” from a participant terminal 30 in the second chatroom 600 and subsequently receives an input content like “Son Heung-min,” the server 10 may apply a transformation rule to add team or club information as additional information. In this case, the terminal 20 may display the transformed content such as “Son Heung-min (Tottenham Hotspur)” 630 through the second chatroom.

The server 10 may determine whether the deactivation condition is satisfied based on the reference information received from the terminal 20. For example, if the deactivation condition is “For 3 minutes after the Korean team scores,” the server 10 may determine whether the Korean team scores, based on website information (e.g., https://sports.daum.net/soccer) received from the terminal 20. When the server 10 receives an input content such as “Goal” within 3 minutes after the score, the server 10 may provide the transformed contents 640 and 650 to the terminal 20, as illustrated in FIG. 5. In this case, the terminal 20 may display the transformed contents 640 and 650 through the second chatroom 600.

However, if the server 10 receives the input content such as “Goal” after the 3-minute period has elapsed, the server 10 may provide the untransformed input content “Goal” 670 to the terminal 20, as illustrated in FIG. 5. In this case, the terminal 20 may display the untransformed input content “Goal” 670 through the second chatroom 600.

The server 10 may determine additional information using an AI model. Specifically, the AI model may determine the additional information based on website information (e.g., “https://sports.daum.net/soccer”) received from the terminal 20. For example, if the AI model identifies keywords related to “Goal” in the second chatroom and subsequently identifies an input content such as “Son Heung-min,” the AI model may determine additional information such as “Son Heung-min (5 goals in this tournament).” Here, “5 goals in this tournament” may be derived from information about Son Heung-min's goals, which the AI model extracts by web crawling the website https://sports.daum.net/soccer. In this case, the terminal 20 may display the transformed content such as “Son Heung-min (5 goals in this tournament)” 660 through the second chatroom 600.

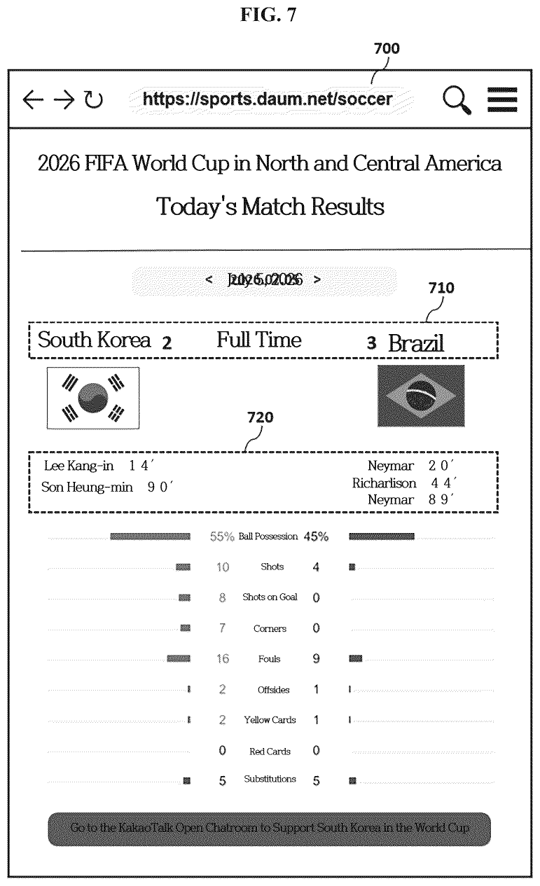

FIG. 7 illustrates an example of reference information received by a server 10 from a terminal 20 according to one embodiment of the present disclosure.

Referring to FIG. 7, the reference data may include information about sports results provided by a specific website (https://sports.daum.net/soccer) 700. The specific website 700 may include World Cup match score information 710 and individual player scoring information 720. The server 10 may determine additional information based on the score information 710 and the scoring information 720. Based on the score information 710, the server 10 may obtain information indicating that South Korea is eliminated from the World Cup.

In some cases, the server 10 may receive a plurality of pieces of reference information from the terminal 20. In such cases, the server 10 may determine additional information based on a plurality of websites. For example, the server 10 may determine additional information based on the most recently updated data in the plurality of websites.

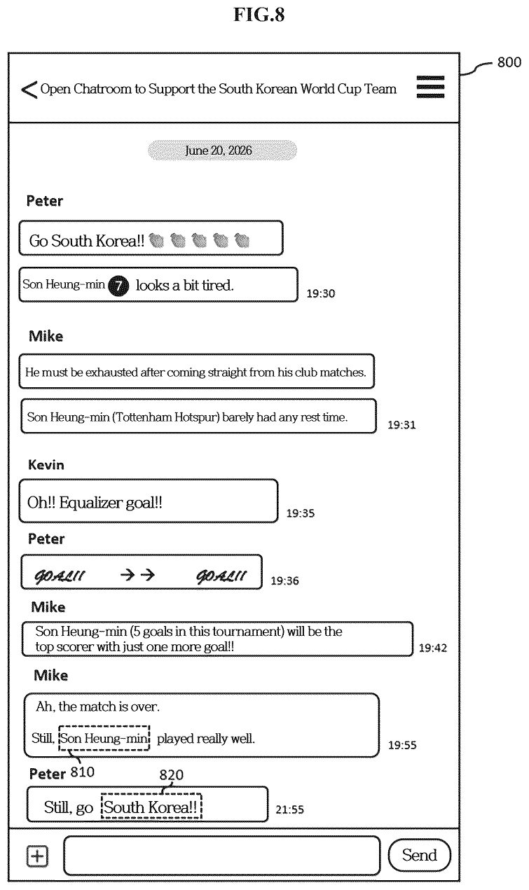

FIG. 8 illustrates a screen in which a terminal 20 according to one embodiment of the present disclosure displays input contents 810 and 820 through a second chatroom 800.

Referring to FIG. 8, the terminal 20 may display the input contents 810 and 820 in the second chatroom 800. Specifically, when the server 10 identifies that the deactivation condition is satisfied, the server 10 may disable the application of configuration information to the second chatroom 800.

In the second chatroom, the deactivation condition for “player name” may be “Until the Korean national team is eliminated.” In this case, if the server 10 identifies the elimination of the Korean national team based on the reference information, the server 10 may disable the application of the configuration information to “player name” in the second chatroom 800.

After the application of the configuration information is disabled, if the terminal 20 transmits an input content related to “player name” through the second chatroom 800, the terminal 20 may display the untransformed content such as “Son Heung-min” (input content) 810 through the second chatroom 800.

Additionally, in the second chatroom, the deactivation condition for “South Korea” may be “2 hours after the first transformation of South Korea is applied.” In this case, since the first transformation is applied at “19:30,” the deactivation condition may be “21:30.” The server 10 may disable the application of the configuration information to “South Korea” at 21:30.

After the application of the configuration information is disabled, if the terminal 20 transmits an input content such as “South Korea” through the second chatroom 800, the terminal 20 may display the untransformed content such as “South Korea” (input content) 820 through the second chatroom 800.

Even if the server 10 identifies that the deactivation condition is satisfied, the terminal 20 may continue to display the previously displayed transformed content as is.

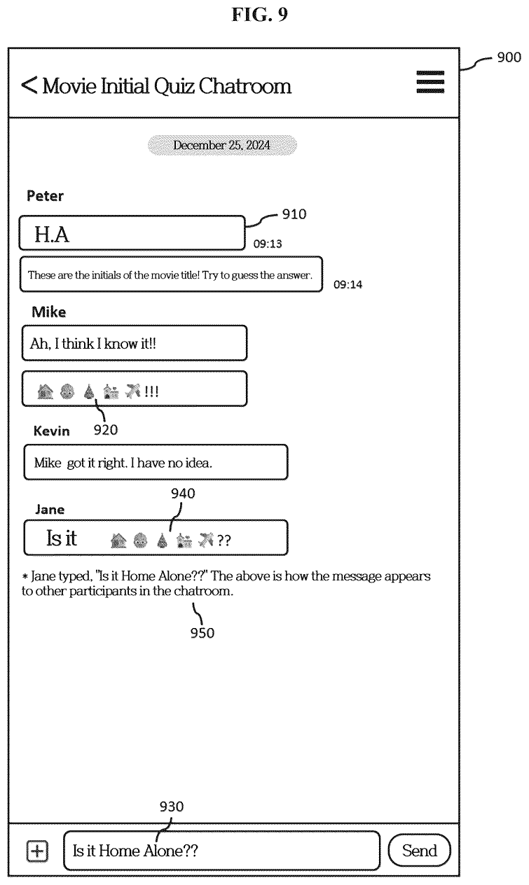

FIG. 9 illustrates a screen in which a participant terminal 30 displays masked contents 920 and 940 through a quiz chatroom 900 according to one embodiment of the present disclosure.

Referring to FIG. 9, a participant terminal 30 may transmit an input content such as “Is it Home Alone??” 930 to a server 10 through the quiz chatroom 900. Here, if the correct answer to a quiz is “Home alone”, the transformation condition may be “Home alone” and “Homealone” (without spacing), etc.

When the server 10 receives from the participant terminal 30 a transmission request for an input content 930 including “Home Alone,” the server 10 may send the masked content 940 to the participant terminal 30 through the quiz chatroom, making “Home Alone” unidentifiable. For example, the masked content may be a content 940 in which “Home Alone” is replaced with emojis.

If there are multiple participants who answer correctly for a quiz question 910, the same masked content may be sent. For example, if another participant terminal (Mike) first sends an input content such as “Home Alone!!!” 920 to the server 10, the participant terminal 30 may display the masked content 920. Subsequently, if the participant terminal 30 again transmits an input content including the correct answer to the question 910, such as “Is it Home Alone??” 930, the server 10 may provide the same masked content 940 for “Home Alone.”

The server 10 may provide both the masked content 940 and information 950 about the input content received from the participant terminal 30. Specifically, if the input content received from the participant terminal 30 matches the correct answer to the quiz, the server 10 may provide both the masked content 940 and the information 950 about the input content.

For example, information about an input content may be a type of feedback message displayed around the masked content 940, such as “Jane typed, “Is it Home Alone?? ” The above is how the message appears to other participants in the chatroom” 950.

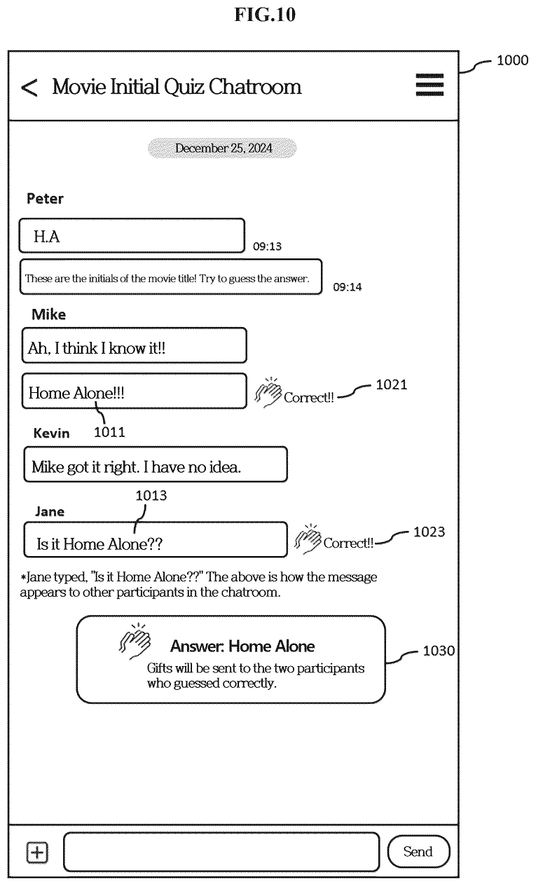

FIG. 10 illustrates a screen where a participant terminal 30 displays a quiz chatroom 1000 with configuration information disabled, according to one embodiment of the present disclosure.

Referring to FIG. 10, a participant terminal 30 may display general contents 1011 and 1013 and information 1021, 1023 and 1030 about a correct answer. Specifically, when the server 10 identifies that a deactivation condition is satisfied, the server 10 may disable the application of configuration information to the quiz chatroom 1000.

When the application of configuration information is disabled in the quiz chatroom 1000, the participant terminal 30 may display the general contents 1011 and 1013. Here, the general contents 1011 and 1013 may be displayed to replace the masked contents. For example, the participant terminal 30 may replace the masked contents 920 and 940 shown in FIG. 9 with a general content, such as “Home Alone.”

When the application of configuration information is disabled in the quiz chatroom 1000, the participant terminal 30 may display the information 1021, 1023, and 1030 about the correct answer. Specifically, the information 1021, 1023, and 1030 about the correct answer may include correct answer emojis 1021 and 1023 around the chat bubbles with the correct answer and a pop-up message 1030 including the correct answer.

For example, the participant terminal 30 may display applause (correct answer) emojis 1021 and 1023 around the messages containing “Home Alone,” entered by “Mike” and “Jane.” In addition, the participant terminal 30 may display a pop-up message such as “Answer: Home Alone, Gifts will be sent to the two participants who guessed correctly” 1030.

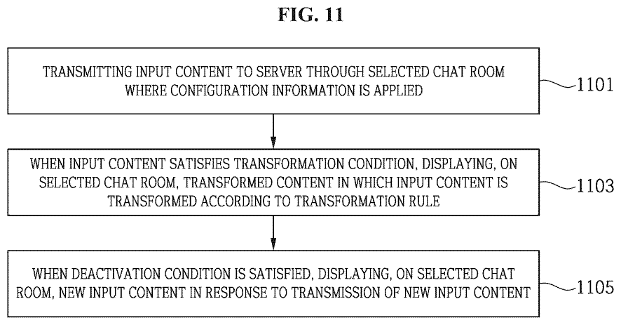

FIG. 11 is a flowchart for explaining a method in which a participant terminal 30 in a selected chatroom of the present disclosure displays a transformed content through the selected chatroom.

For convenience of explanation, the description of operations in FIG. 11 that are substantially identical to operations in FIG. 2 will be replaced with a description referring to FIG. 2.

In operation 1101, the participant terminal 30 transmits an input content to a server 10 through a selected chatroom with configuration information applied. Since operation 1101 is substantially identical to operations 201 and 203 of FIG. 2, the description of operation 1101 is replaced with the description of operations 201 and 203 of FIG. 2.

In operation 1103, if the input content satisfies a transformation condition, the participant terminal 30 displays in the selected chatroom a transformed content in which the input content is transformed according to a transformation rule. Since operation 1103 is substantially identical to operations 205 and 207 of FIG. 2, the description of operation 1103 is replaced with the description of operations 205 and 207 of FIG. 2.

In operation 1105, if the deactivation condition is satisfied, the participant terminal 30 displays a new input content in the selected chatroom, without transformation, in response to the transmission of the new input content. Since operation 1105 is substantially identical to operation 209 of FIG. 2, the description of operation 1105 is replaced with the description of operation 209 of FIG. 2.

The present disclosure has the advantage of providing a feature that enables a server to transmit an input content entered by a user through a chatroom as a transformed content, in which the input content is transformed according to a transformation rule, to attract the attention or arouse the interest of chatroom participants.

In addition, the present disclosure has the advantage of providing a feature that enables the server to determine whether a condition to disable the application of configuration information related to content transformation applied to a chatroom is satisfied, and to disable the application of configuration information at an appropriate time intended by a setter.

The technical features disclosed in each embodiment of the present disclosure are not limited to a corresponding embodiment, and unless incompatible with each other, the technical features disclosed in each embodiment may be applied in combination to other embodiments.

Therefore, although each embodiment is described mainly about an individual technical feature, the technical features of the embodiments of the present disclosure may be applied in combination, unless incompatible with each other.

The present disclosure is not limited to the above-described embodiments and the accompanying drawings, and various modifications and changes may be made in view of a person skilled in the art to which the present disclosure pertains. Therefore, the scope of the present disclosure should be determined by the scope of the appended claims, and equivalents thereof.

What is claimed is:

1. A method for providing a transformed content by a server through a chatroom, the method comprising:
receiving configuration information related to content transformation applied to at least one selected chatroom from a terminal, wherein the configuration information comprises a transformation condition, a transformation rule, and a deactivation condition for disabling application of the configuration information;
applying the configuration information to the selected chatroom; and
in response to the deactivation condition being satisfied, disabling the application of the configuration information to the selected chatroom,
wherein applying the configuration information comprises:
receiving a transmission request for the input content through the selected chatroom from a participant terminal of the selected chatroom; and
in response to the input content satisfying the transformation condition, transmitting the transformed content, in which the input content is transformed according to the transformation rule, to the participant terminal through the selected chatroom.

2. The method of claim 1, wherein the configuration information is set differently depending on the selected chatroom.

3. The method of claim 1, wherein disabling the application of the configuration information comprises determining whether the deactivation condition is satisfied based on reference information specified by the terminal.

4. The method of claim 1, wherein the configuration information is not provided to the participant terminal of the selected chatroom.

5. The method of claim 1, wherein a starting point for the deactivation condition comprises a point in time when initial transmission of the transformed content according to the configuration information is performed.

6. The method of claim 1, wherein an artificial intelligence (AI) model is used for at least one of: determining whether the transformation condition is satisfied, determining the transformed content according to the transformation rule, or determining whether the deactivation condition is satisfied.

7. The method of claim 1, wherein the transformation condition is whether the input content corresponds to a transformation target content or a similar content of the transformation target content according to a predetermined criterion.

8. The method of claim 1, wherein:
the configuration information is stored in the server or terminal, and
receiving the configuration information comprises receiving a request to retrieve the stored configuration information from the terminal.

9. The method of claim 1, wherein transmitting the transformed content comprises determining one content selected from a transformation variant content set corresponding to the input content according to the transformation rule as a transformed content.

10. The method of claim 9, wherein at least one content from the transformation variant content set is generated by an AI model based on the transformation condition.

11. The method of claim 1, wherein transmitting the transformed content comprises determining the transformed content based on chat history of the selected chatroom.

12. The method of claim 1, wherein the transformed content comprises a predetermined type of additional information for the input content.

13. The method of claim 12, further comprising updating the additional information through a predefined database or an AI model.

14. The method of claim 1, wherein:
the transformation condition is whether the input content is related to a correct answer to a quiz provided in the selected chatroom, and
the transformed content is a masked content that makes the correct answer unidentifiable.

15. The method of claim 14, wherein while the configuration information is applied to the selected chatroom, the masked content is provided for any content related to the correct answer.

16. A server providing a transformed content through a chatroom, the server comprising:
a memory storing instructions; and
a processor connected to the memory and configured to execute the instructions to:
receive configuration information related to content transformation applied to at least one selected chatroom from a terminal, wherein the configuration information comprises a transformation condition, a transformation rule, and a deactivation condition for disabling application of the configuration information;
apply the configuration information to the selected chatroom; and
in response to the deactivation condition being satisfied, disable the application of the configuration information to the selected chatroom, wherein applying the configuration information comprises:
receiving a transmission request for the input content through the selected chatroom from a participant terminal of the selected chatroom; and
in response to the input content satisfying the transformation condition, transmitting the transformed content, in which the input content is transformed according to the transformation rule, to the participant terminal through the selected chatroom.

17. A method for displaying a transformed content through a chatroom by a terminal, the method comprising:
transmitting an input content to a server through a selected chatroom with configuration information applied, wherein the configuration information comprises a transformation condition, a transformation rule, and a deactivation condition for disabling the application of the configuration information;
in response to the input content satisfying the transformation condition, displaying in the selected chatroom a transformed content in which the input content is transformed according to the transformation rule; and
in response to the deactivation condition being satisfied, displaying a new input content in the selected chatroom in response to transmission of the new input content.
